(19) United States
(12) Patent Application Publication
(10) Pub. No.: US 2026/0115919 A1
(43) Pub. Date: Apr. 30, 2026

(54) ROBOTICS SAFETY SUBSYSTEM

(71) Applicant: Sensory Robotics, Inc., New Castle, DE (US)

(72) Inventors: Chris Edwards, Cincinnati, OH (US); Tristan Fogt, Gladwyne, PA (US)

(73) Assignee: Sensory Robotics, Inc., New Castle, DE (US)

(21) Appl. No.: 18/931,791

(22) Filed: Oct. 30, 2024

(51) Int. Cl. B25J 9/16

(52) U.S. Cl. CPC B25J 9/1676; B25J 9/1605

(57) ABSTRACT

For a (stationary or mobile) robot within a monitored space, a safety subsystem generates a virtual representation of the robot using position and/or orientation data associated with the robot, detects an unexpected object within the monitored space using sensor data from a plurality of (external/internal) sensors, detects a virtual halt collision between the virtual robot and the virtual unexpected object based on a halt zone corresponding to the robot or the unexpected object, and generates an instruction to halt the normal operations of the robot. The (dynamic) virtual robot representation may include a robot arm movable with respect to the robot's base. The monitored space is generated by removing ignore zones corresponding to expected objects, including an ignore zone corresponding to the robot itself, from an initial (e.g., spherical) version of the monitored space. Regions having insufficient sensor coverage (i.e., IPZs) are treated as unexpected objects within the monitored space.

### BACKGROUND

### Field of the Disclosure

The present disclosure relates to robotics and, more specifically but not exclusively, to technology enhancing safety in industrial robotics applications.

### Description of the Related Art

This section introduces aspects that may help facilitate a better understanding of the disclosure. Accordingly, the statements of this section are to be read in this light and are not to be understood as admissions about what is prior art or what is not prior art.

The use of industrial robots in manufacturing spaces is ubiquitous. Unfortunately, along with that use comes the possibility of undesirable physical interactions between those robots and other entities including personnel that can result in injuries to those humans and/or damage to the robots.

### SUMMARY

Problems in the prior art are addressed in accordance with the principles of the present disclosure by technology designed to enhance the safety of industrial robots by actively monitoring their operating environments and regulating their movements based on precise, real-time data analysis. The technology serves to prevent potential accidents involving personnel or unintended interactions with the robots, thereby ensuring a safe working environment in industrial settings.

Certain embodiments of the present disclosure are designed for diverse industrial applications, ensuring comprehensive coverage by requiring full visibility of each robot's range and halt radius through at least two cameras. These embodiments support multiple robots and integrate seamlessly with existing industrial setups, utilizing, for example, standard Ethernet infrastructure for robust communication and control. Embodiments preferably adhere to international safety standards for robotic operations. Through advanced features, including redundancy in data processing and real-time synchronization, these embodiments maintain a high level of operational safety and reliability, crucial for industrial environments.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a schematic block diagram representing the hardware infrastructure of an industrial robotics system according to certain embodiments of the present disclosure;

FIG. 2 is a perspective view of an example of the robot of FIG. 1;

FIG. 3 is a perspective view of an example of the robot of FIG. 1 with its arm fully extended;

FIG. 4 is a perspective view of the fully extended robot of FIG. 3 located in a workspace having two walls, a floor, and a workbench;

FIG. 5 is a representation of the robot of FIG. 1 with its arm at a particular orientation relative to its base;

FIG. 6 is a representation of a sensor 120 of FIG. 1 illustrating the range Δz and angle θ between the sensor and an example point in the sphere;

FIG. 7A represents a situation in which the received joint angles are sufficiently accurate such that the points of the virtual representation of the robot sufficiently conform to the actual configuration of the physical robot;

FIG. 7B represents a situation in which some or all of received joint angles are sufficiently erroneous such that the points of the virtual representation of the robot do not sufficiently conform to the actual configuration of the physical robot;

FIG. 8 is a flow diagram of processing performed by each processing computer of FIG. 1 according to certain implementations; and

FIG. 9 is a schematic block diagram representing the hardware infrastructure of an industrial robotics system according to certain other embodiments of the present disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

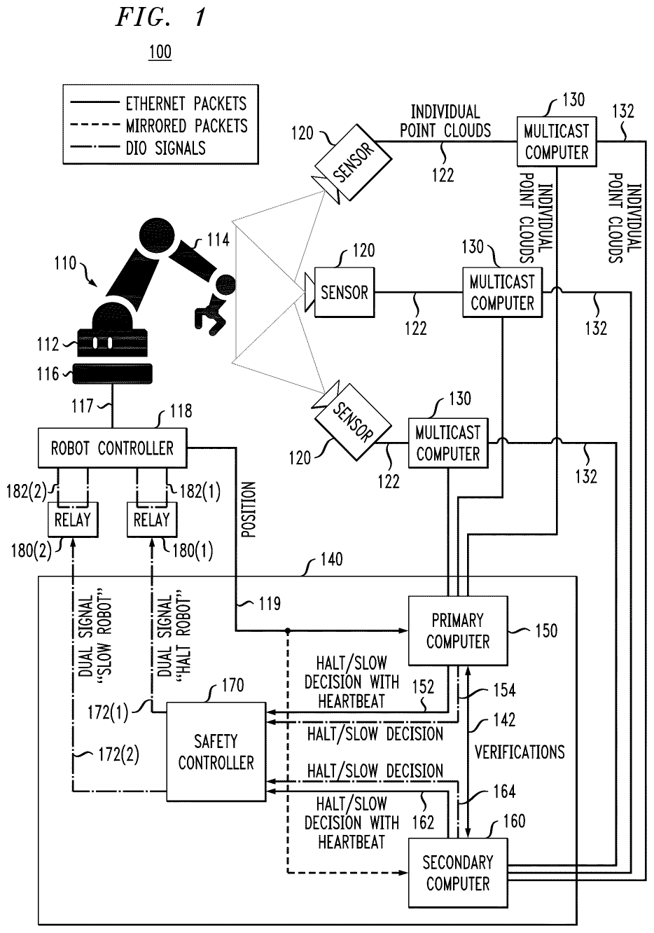

FIG. 1 is a schematic block diagram representing the hardware infrastructure of an industrial robotics system 100 according to certain embodiments of the present disclosure. As shown in FIG. 1, robotics system 100 includes a “stationary” industrial robot 110 having an immobile base 112 and a movable, articulated arm 114 that can move through three-dimensional space relative to the base 112 to perform specific manufacturing tasks. Here, “base” refers generically to the structure to which the robot's arm 114 is connected, and “stationary” means that the robot's base 112 does not move relative to the robot's environment.

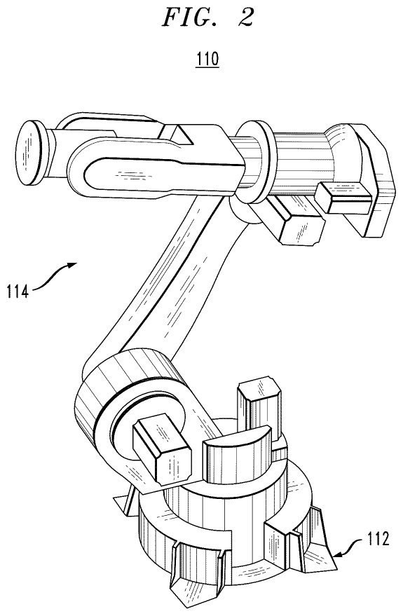

FIG. 2 is a perspective view of an example of the robot 110 of FIG. 1. As shown in FIG. 2, this robot's arm 114 has a series of segments rotationally interconnected to the base 112 and to each other at joints that collectively enable the arm 114 to move relative to the base 112 to perform industrial operations. The current orientation of the robot's arm 114 relative to the base 112 can be identified by the current values of the rotational angles of those joints.

Referring again to FIG. 1, robot 110 also has electronics 116 that control the operations of the arm 114 based on instructions received from a robot controller 118 via signal path 117. Note that, in this specification, the same figure label may be used to represent both a particular signal path and the signals transmitted via that signal path. Thus, for example, the label “117” may be used to represent both the signal path 117 shown in FIG. 1 and the instructions carried on that signal path.

The robot controller 118 can be programmed, for example, to instruct the electronics 116 to move the arm 114 relative to the base 112 to move reachable workpieces (not shown in FIG. 1) one at a time from their current location to a different location within the robot's reach. Those skilled in the art will appreciate the wide variety of industrial operations that can be performed by industrial robots such as, but not limited to, robot 110.

Robotics system 100 also has a plurality of sensors (e.g., 3D cameras) 120, a plurality of corresponding multicast computers 130, a safety subsystem 140, and two relays 180(1) and 180(2), where the safety subsystem 140 includes primary and secondary processing computers 150 and 160 and a safety controller 170. As understood by those skilled in the art, the sensors 120 are positioned and oriented in 3D space to generate different, respective views of the robot 110 and its immediate surrounding environment.

The primary function of the safety subsystem 140 is to detect when the robot's articulated arm 114 is in danger of coming into physical contact with an unexpected object, such as a person (not shown in FIG. 1), located near the robot 110. In that case, depending on the particular situation, the safety subsystem 140 will instruct the robot 110 either to (i) slow down the motion of the robot's arm 114 relative to the robot's base 112 or (ii) halt the motion of the robot's arm 114.

As described further below, the safety subsystems 140 distinguishes between two different types of objects: expected objects whose existence is programmed into the processing computers 150/160 and unexpected objects whose existence is not programmed into the processing computers 150/160, but whose existence is detected in near real time by the processing computers 150/160 based on the current signals from the sensors 120. As used herein, the term “near real time” refers to be ability to process and/or respond within a second (as opposed to real time, which refers to the ability to process and/or respond within a few milliseconds). In any case, near real time implies the ability of the generated virtual world to stay sufficiently consistent with the real world to achieve the desired safety goals. Upon detection of sufficient proximity of any part of the robot 110 to any part of an unexpected object, the safety subsystem 140 will command the robot 110 to slow down or halt the motion of the robot's arm 114 depending on that proximity. Detected proximity of the robot 110 to an expected object will not result in the safety subsystem 140 interfering with the normal operations of the robot 110.

Each sensor 120 generates and sends corresponding sensor signals via a corresponding signal path 122 to the corresponding multicast computer 130, which duplicates and transmits (i.e., multicasts) the corresponding sensor signals to the IP addresses of the primary and secondary processing computers 150 and 160 via corresponding signals paths 132. Depending on the type of sensor 120, the sensor signals 132 contain point-cloud data, depth-map data, or some other suitable type of data. The following discussion assumes that the sensor signals 132 contain point-cloud data. For embodiments where the sensor signals 132 contain depth-map data or some other suitable type of data, the sensor signals 132 will be converted into point-cloud data by the processing computers 150 and 160. Each pixel (u,v) in a depth map can be converted into a 3D point (x,y,z) in a corresponding point cloud with, for example, the following equations:

$$z = d / depth\_scale$$

$$x = ( u - cx ) * z / fx$$

$$y = ( v - cy ) * z / fy$$

where u is the horizontal coordinate of the pixel in the depth map and v is the vertical coordinate of the pixel in that depth map, d=depth map pixel value, depth_scale=depth scaling factor, cx, cy=principal point coordinates (camera center in image space), and fx, fy=focal lengths in pixel units.

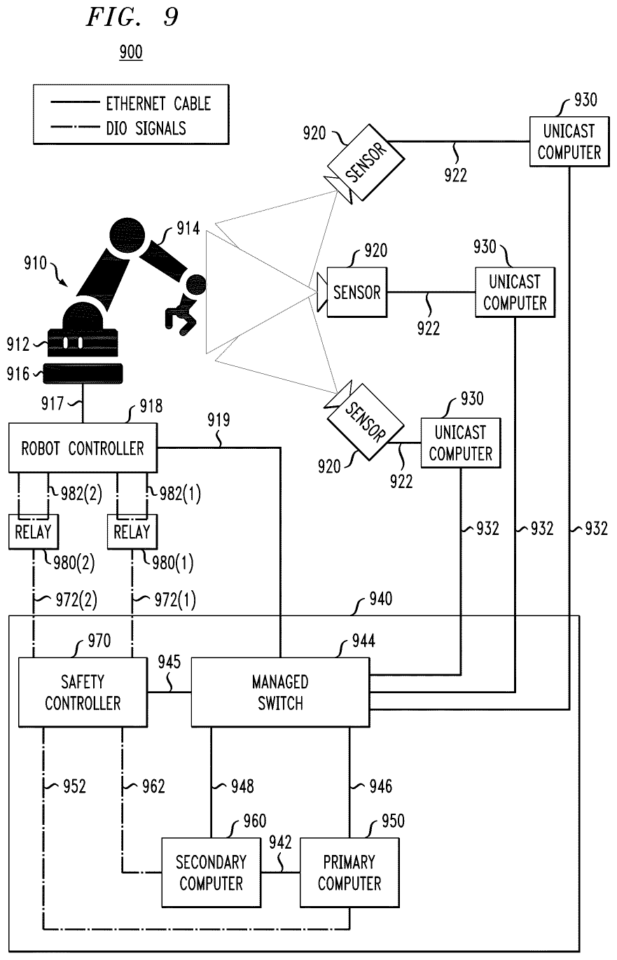

Multicasting involves each sensor 120 sending its data to a switch (such as switch 944 of FIG. 9) via standard multicast protocols, and each processing computer 150 and 160 subscribes to the multicast on the switch. Alternatively, multicasting can involve each multicast computer 130 interfacing with the corresponding sensor 120 directly, where each multicast computer 130 runs a script to forward data packets to the processing computers 150 and 160. In some implementations, the point-cloud data 132 is transmitted via UDP Ethernet packets, although other suitable data-transfer mechanisms may be employed. In addition to the point-cloud data 132, the primary and secondary processing computers 150 and 160 receive robot orientation data from the robot controller 118 via signal path 119 reflecting the joint angles associated with the current orientation of the robot's arm 114 relative to the robot's base 112.

If a person or other unexpected object enters the robot's workspace, a physical collision can occur between the robot 110 and that unexpected object resulting in harm to the object and/or damage to the robot. In order to prevent actual physical collisions, the safety subsystem 140 (i) detects so-called virtual collisions between the robot 110 and an unexpected object by determining when the virtual representation of an unexpected object is too close to the virtual representation of robot 110 and (ii) halts the movement of the real-world robot's arm 114 to attempt to avoid a physical collision between the robot 110 and the object. Note that the safety subsystem 140 can prevent the robot's arm 114 from continuing to move toward the unexpected object, but cannot prevent the object from continuing to move towards the robot 110.

To determine when unexpected objects are too close to the robot 110, the safety subsystem 140 uses (i) the angle data 119 from the robot controller 118 to determine the current orientation of the robot's arm 114 and (ii) the point-cloud data from the sensors 130 to monitor the 3D workspace around the robot 110 for unexpected objects.

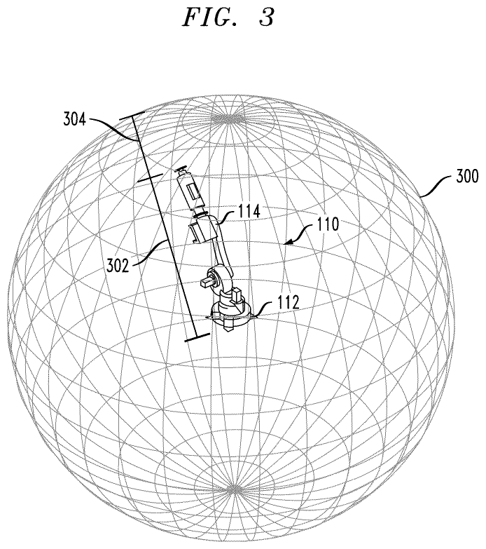

FIG. 3 is a perspective view of the robot 110 of FIG. 2 with its arm 114 fully extended. This orientation of the robot's arm 114 is used to define, around the robot 110, a sphere 300 whose radius is (i) the distance 302 from the center of the robot's base 112 to the end of the fully extended arm 114 plus (ii) an additional distance 304 referred to herein as the halt radius. As described further below, the halt radius is the distance between a sufficient portion of the robot's arm 114 and sufficient portion of an unexpected object that will trigger the safety subsystem 140 to halt the arm's motion. The halt radius is selected to be sufficiently large to prevent a collision between any part of the robot's arm 114 and a human in the time it takes for the system to detect and report a collision and for the robot arm 114 to come to a complete stop.

The sphere 300 encapsulates all of the possible collision points in 3D space that the safety subsystem 140 would need to monitor in order to detect virtual collisions between the robot 110 and an unexpected object. Note that the sphere 300 also encapsulates points that the robot's arm 114 cannot reach. Nevertheless, it is mathematically efficient to encapsulate all of the possible collision points using a sphere. Those skilled in the art will understand that sufficiently large shapes other than spheres can be used in other implementations.

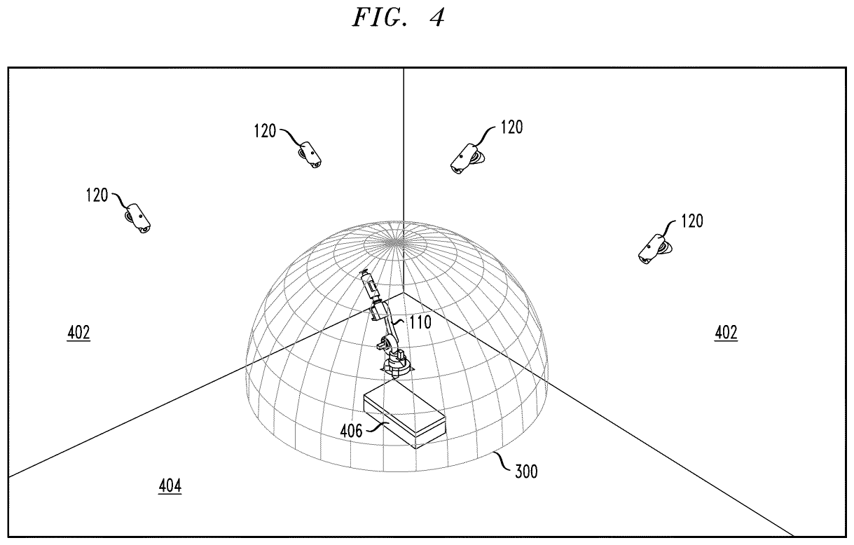

FIG. 4 is a perspective view of the fully extended robot 110 of FIG. 3 located in a workspace having two walls 402 and a floor 404. In the representation of FIG. 4, the sphere 300 of FIG. 3 is truncated at the two walls 402 and at the floor 404. The portions of the sphere 300 beyond the walls 402 and the floor 404 represent regions of 3D space referred to herein as “ignore zones” that the safety subsystem 140 does not need to monitor, because it is assumed that these regions are not accessible to a person and/or to the robot arm 114.

Unlike an unexpected object such as a person who enters the robot's workspace, the ignore zones corresponding to the walls 402 and the floor 404 and the 3D spaces beyond them are treated as expected objects when the safety subsystem 140 performs its collision-detection processing. As such, the points in the 3D space of the full sphere 300 of FIG. 3 corresponding to those ignore zones are removed from the set of points to be monitored by the safety subsystem 140. As a result, the close proximity of the robot's arm 114 to the ignore zone corresponding to an expected object will not result in the safety subsystem 140 triggering the robot's arm 114 to slow down or halt.

Note that the walls 402 and floor 404 of FIG. 4 may be part of a rectilinear “cell” that defines the robot's environment. Such a cell may be defined by identifying the location of opposite corners (e.g., near upper left and far lower right) of the rectilinear cell. The boundaries of that cell (e.g., including the walls 402 and floor 404 of FIG. 4) define where, if at all, the sphere 300 of FIG. 3 is truncated.

FIG. 4 also shows a workbench (or, alternatively, a pallet) 406 located within the sphere 300. This workbench 406 may be a location from or to where the robot 110 moves workpieces (not shown in FIG. 4). The 3D region corresponding to the workbench 406 defines another ignore zone that is treated as an expected object whose points are removed from the sphere 300. As such, the safety subsystem 140 will not trigger the robot's arm 114 to slow down or halt when the arm 114 comes near the workbench 406. Note that workpieces (not shown) that may be on or in the workbench 406, could also be included within the ignore zone, or they could have their own ignore zone, such that the safety subsystem 140 will not trigger when the robot 110 handles those workpieces.

An ignore zone is generated to ignore the points within the sphere 300 corresponding to the robot 110 itself (referred to as the robot's reflection region) as this is an expected object. Note that, unlike the ignore zones corresponding to the walls 402, floor 404, and workbench 406 which are static, the ignore zone corresponding to the robot 110 is dynamic due to the everchanging orientation of the robot's arm 114 with respect to the robot's base 112 as the robot 110 performs its industrial operations.

The remaining volume shown in FIG. 4 after removing, from the sphere 300 of FIG. 3, the ignore zones corresponding to the walls 402, the floor 404, the workbench 406, and the robot 110 itself represents the set of points in 3D space that the safety subsystem 140 is responsible for monitoring for virtual collisions between the robot 110 and unexpected objects. The term “monitored space” will be used to refer to this set of points.

Note that, when designing the robot's workspace, any passageways into that workspace should be located away from the safety subsystem's monitored space so that persons and other unexpected objects will not have to cross into the monitored space in order to enter the robot's environment.

FIG. 4 also shows four different sensors 120 mounted onto the two walls 402. Those skilled in the art will understand that a typical workspace may have additional sensors 120 (not shown in FIG. 4), where the collection of sensors 120 ideally provides a full view of the monitored space for all possible orientations of the robot's arm 114.

The primary and secondary processing computers 150 and 160 both process the sets of point-cloud data 132 received from the multicast computers 130 and the robot orientation data 119 received from the robot controller 118 in parallel to generate independent determinations as to whether the motion of the robot 110 should be slowed or halted or allowed to continue as normal.

The segments of the robot's arm 114 may be represented mathematically by a set of line segments interconnected by joints, where the lengths and interconnections of those line segments are pre-programmed into the processing computers 150 and 160. In some implementations, each processing computer 150/160 employs forward kinematics to calculate the current orientation of the robot's arm 114 based on the current joint angles 119 received from the robot controller 118, where the current configuration of each joint is calculated by applying a corresponding transformation matrix to the previous joint configuration, starting from its original joint configuration.

The 3D thickness of each segment of the robot's actual arm 114 may be represented by a specified dilation radius, which may differ from segment to segment. Any points that are within the dilation radius of a segment's line are treated as being part of that segment and are excluded from collision calculations for the robot via the aforementioned dynamic ignore zone.

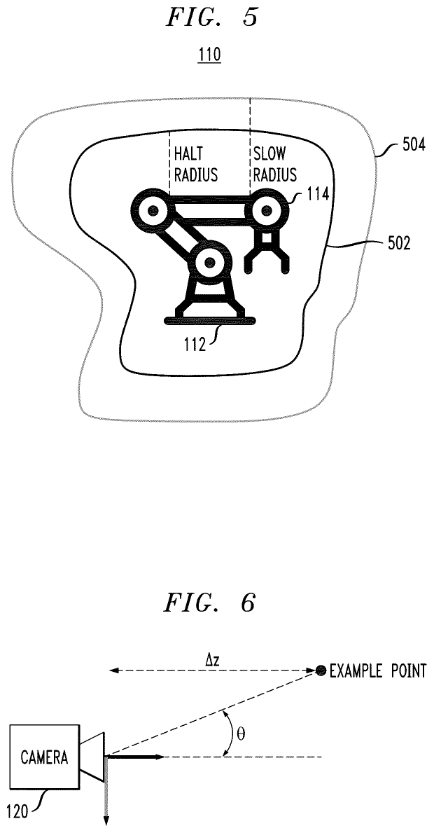

FIG. 5 is a representation of the robot 110 of FIG. 1 with its arm 114 at a particular orientation relative to its base 112. As described above, each processing computer 150/160 uses the current joint data 119 received from the robot controller 118 to generate a current representation of the robot 110. As represented in FIG. 5, each processing computer 150/160 uses that the current representation of the robot 110 itself to generate (i) a (virtual) three-dimensional “halt” zone 502 surrounding the robot 110 based on the “halt” radius representing a specified, fixed distance between the outer surface of the halt zone 502 and the nearest part of the robot 110 and (ii) a larger, (virtual) three-dimensional “slow” zone 504 surrounding the robot 110 based on a so-called “slow” radius representing a longer, specified, fixed distance between the outer surface of the slow zone 504 and the nearest part of the robot 110.

Note that each processing computer 150/160 updates the halt and slow zones 502 and 504 in near real time to move with and conform to the current orientation of the robot's arm 114 as the arm moves with respect to the robot's base 112.

Each processing computer 150/160 uses the near-real-time point-cloud data 132 received from the multicast computers 130 to detect unexpected objects in the monitored space. The distance between each point in the point cloud and each line segment of the robot is calculated, and is compared against the halt/slow radii, plus the segment thickness (dilation radius).

If and when the primary processing computer 150 determines that a sufficient portion of an unexpected object, such as a person, within the monitored space is within the slow zone 504, then the primary processing computer 150 will detect a virtual “slow” collision and therefore determine that the motion of the robot's arm 114 relative to the robot base 112 should slow down, e.g., to be no greater than to a specified, “slow” speed limit. If and when the primary processing computer 150 determines that a sufficient portion of an unexpected object within the monitored space is within the halt zone 502, then the primary processing computer 150 will detect a virtual “halt” collision and therefore determine that the motion of the robot's robot arm 114 relative to the robot base 112 should be stopped. If no virtual collision is detected, then the primary processing computer 150 will determine that the normal operations of the robot 110 may continue.

Concurrent with the above processing by the primary processing computer 150, the secondary processing computer 160 receives data from the sensor(s) 120 or multicasting computer(s) 130 and robot controller 118 and performs the same operations as the primary processing computer 150 for redundancy. The secondary computer 160 generates an independent determination of whether the motion of the robot's arm 114 should be slowed or halted or allowed to continue as normal.

The processing computers 150 and 160 share their halt/slow/continue decisions with each other via signal path 142 to determine whether their decisions match. If either processing computer 150/160 determines that its decision is different from the other processing computer's decision, then that processing computer will determine that the robot 110 should be halted on the basis of that disagreement.

In any case, the primary processing computer 150 sends the results of its determination to the safety controller 170 via signal path 152, while the second processing computer 160 sends the results of its own independent determination to the safety controller 170 via signal path 162. In some implementations, for added safety, each signal path 152/162 has an additional, redundant digital I/O (DIO) cable 154/164 connected between digital output ports on the corresponding processing computer 150/160 and digital input ports on the safety controller 170 to redundantly convey the corresponding halt/slow/continue decision from the corresponding processing computer 150/160 to the safety controller 170.

The safety controller 170 compares and analyzes the determinations 152 and 162 received from the primary and secondary processing computers 150 and 160, respectively, to determine whether to instruct the robot 110 to slow down or halt or to allow the robot 110 to continue to operate as normal.

In certain implementations, each of the signals 152 and 162 respectively transmitted from the processing computers 150 and 160 to the safety controller 170 has (i) a “slow” bit which indicates with a positive bit value of 1 that the robot 110 should slow down its operations and (ii) a “halt” bit which indicates with a positive bit value of 1 that the robot 110 should halt its operations. In some implementations, the “slow” bit will have a bit value of 0 to indicate that the robot should slow, and the “halt” bit will have a value of 0 to indicate that the robot will halt. The particular implementation is configurable on the computers 150 and 160 and the safety controller 170 and should be configured to match the Normally Open and Normally Closed convention of the jurisdiction or customer.

If the processing computers 150 and 160 are both operating properly, then the values of the “slow” and “halt” bits in the primary signal 152 will be identical to the values of the “slow” and “halt” bits in the secondary signal 162. The safety controller 170 compares the primary and secondary signals 152 and 162. If the safety controller 170 determines that the values of the “slow” and “halt” bits in the primary signal 152 are different from the values of those two bits in the secondary signal 162, then the safety controller 170 determines that the robot 110 should be halted.

If the safety controller 170 determines that the two bits in the primary signal 152 match the two bits in the secondary signal 162, then the safety controller 170 performs the following analysis:
If the “halt” bits are positive, then, independent of the value of the “slow” bits, the safety computer 170 will determine that the robot 110 should be halted;
If the “halt” bits are negative (i.e., both 0) and the “slow” bits are positive, then the safety computer 170 will determine that the robot 110 should slow down; and
If the “halt” bits and the “slow” bits are all negative, then the safety computer 170 will determine that the robot may continue to operate as normal.

If the safety controller 170 determines that the robot 110 should be halted, then the safety controller 170 (i) transmits a “halt robot” signal by changing the voltage across the connection 172(1) to the first (“halt”) relay 180(1), and this causes the halt relay 180(1) to open the first relay loop 182(1). The opening of this relay loop 182(1) instructs the robot controller 118 to halt the motion of the robot arm. Since the relays 180 are “normally open” (NO) for a safe-failure condition, the relays are kept closed (not triggering) by the safety controller 170. Thus, in a power-loss situation, the halt relay 180(1) will open by default and the robot 110 will be triggered to halt.

If, the safety controller 170 determines that the robot 110 should be slowed down, then the safety controller 170 (i) transmits a “slow robot” signal by changing the voltage across the connection 172(2) to the second (“slow”) relay 180(2), and this causes the slow relay 180(2) to open the second relay loop 182(2). The opening of this relay loop 182(2) instructs the robot controller 118 to slow down the motion of the robot arm 114.

If, instead, the safety controller 170 determines that the robot 110 does not need to be either halted or slowed down, then the safety controller 170 will not transmit a signal to either the halt relay 180(1) or the slow relay 180(2), thereby allowing the robot controller 118 to continue to operate the robot arm 114 as normal.

Note that, in some implementations, each of signal paths 172(1) and 172(2) is a dual-signal DIO cable that redundantly carries respective dual signals to its corresponding relay 180.

Note that, depending on the particular implementation, the different signal paths between the various elements in FIG. 1 may be via different suitable connections such as (without limitation) Ethernet cables and/or USB connections that transmit corresponding data packets, or wireless connections such as (without limitation) WiFi.

In certain implementations, the following products may be used to implement the following elements in FIG. 1:
Robot 110 with robot controller 118: A VP-6242 robot from Denso Robotics of Long Beach, CA;
Each sensor 120: A safeVisionary2 safety camera sensor from SICK Gmbh of Wiener Neudorf, Austria;
Each multicast computer 130: A CL250 edge gateway from OnLogic of South Burlington, Vermont;
Each processing computer 150/160: A Helix 511 edge computer from OnLogic;
Safety controller 170: An R1.190.1310.0 configurable control component from Wieland Electric Gmbh of Bamberg, Germany; and

Each relay 180: A 62 Series NO power relay from Finder Spa of Almese, Italy.

### 3D Environmental Monitoring

Each processing computer 150/160 combines the separate point clouds 132 received from the multiple sensors 120 together into a single, global point cloud, using the (e.g., fixed) camera position data, for example, entered by the operator during configuration. This is done by taking the cross-product of the homogenized points and the inverse of the transform matrix of the corresponding sensor 120 to generate a point cloud in a global coordinate system as follows:

$${[ \begin{matrix}{r}_{1} & {r}_{2} & {r}_{3} & {t}_{x} \\ {r}_{4} & {r}_{5} & {r}_{6} & t - y \\ {r}_{7} & {r}_{8} & {r}_{9} & {t}_{z} \\ 0 & 0 & 0 & 1\end{matrix} ]}^{- 1} \times [ \begin{matrix}{x}_{1} & {x}_{2} & {x}_{3} & \\ {y}_{1} & {y}_{2} & {y}_{3} & \\ {z}_{1} & {z}_{2} & {z}_{3} & … \\ 1 & 1 & 1 & \end{matrix} ] = [ \begin{matrix}{x}_{1}^{′} & {x}_{2}^{′} & {x}_{3}^{′} & \\ {y}_{1}^{′} & {y}_{2}^{′} & {y}_{3}^{′} & \\ {z}_{1}^{′} & {z}_{2}^{′} & {z}_{3}^{′} & … \\ 1 & 1 & 1 & \end{matrix} ]$$

where point n is deconstructed into xₙ,yₙ,zₙ. The transformation matrix consists of the rotation matrix r₁ through r₉ and the translation vector tₓ,t_{y},t_{z}. Transformed point n is denoted as

$${x}_{n}^{′} , {y}_{n}^{′} , {z}_{n}^{′} .$$

In order to reduce computational load, each processing computer 150/160 may then reduce the point-cloud density. For example, points within a certain distance of each other (e.g., set by the operator during configuration) may be consolidated into a single point. This can be done by dividing the virtual space into cubic regions and replacing all points within each cubic region with a single point at the center of the region. As discussed below, positional uncertainty associated with this consolidation is taken into account when the halt radius is calculated.

Ideally, the sensors 120 have full, redundant coverage of the robot 110, where redundant coverage means that every point in the monitored space is in view of at least two different sensors 120. Those skilled in the art will understand that, in other implementations, full coverage may involve each point in the monitored space being in view of at least only one sensor 120 or being in view of a specified number of sensors 120 greater than two.

Each point in the monitored space is checked against each sensor 120 to ensure that the point is within the range and field-of-view (FoV) of at least two sensors. This is done by comparing each point against each sensor's origin in that sensor's coordinate frame (i.e., not transformed onto the global coordinate frame). Since the sensor's line of sight is its own z-axis, it can be determined if the point is within range of the sensor 120 by verifying that the difference in z coordinates between the point and the sensor origin is less than the sensor's range (Δz). In addition, it can be determined if the point is within the sensor's height and width FoV by measuring the angle (θ) formed by the Z-axis and the line from the point to the origin projected onto the XZ and YZ planes, respectively. If a point is not within both the range and FoV of at least two sensors 120, then, as described further below, that point will be treated as being part of an implied presence zone (IPZ).

FIG. 6 is a representation of a sensor 120 of FIG. 1 illustrating the range Δz and angle θ between the sensor and an example point in the monitored space.

Proximity Detection with Halt and Slow Radii

The above section describes how each processing computer 150/160 creates a point cloud of everything within the monitored space. Each processing computer 150/160 uses the sensors' point-cloud data 132 to detect unexpected objects, where an unexpected object is any object determined to be within the monitored space. If a processing computer 150/160 determines that a sufficient portion of an unexpected object intersects with a sufficient portion of the robot's slow zone 504, then a slow collision is detected and the robot's arm 114 is slowed down. If a processing computer 150/160 determines that a sufficient portion of an unexpected object intersects with a sufficient portion of the robot's halt zone 502, then a halt collision is detected and the robot's arm 114 is halted. In some implementations, the size of the halt radius is defined by ISO/TS 150662016(E), based on a number of factors including the robot's maximum speed, the robot's stop time, the system latency time, robot position/orientation uncertainty, and point-cloud position uncertainty. In particular, the stopping distance of the robot 110 may be determined according to ISO 10218-1:2011, Annex B. The protective separation distance Sₚ(t₀) (i.e., the halt radius) at time t₀ can be described by the following formula:

$${S}_{p} ( {t}_{0} ) = {S}_{h} + {S}_{r} + {S}_{s} + C + {Z}_{d} + {Z}_{r}$$

where:
Sₚ(t₀) is the protective separation distance at time t₀, where t₀ is the present or current time;
Sₕ is the contribution to the protective separation distance attributable to the operator's change in location, e.g., the distance a person can move in the time it takes for the safety subsystem 140 to detect a halt collision and then cause the robot's arm 114 to halt;
Sᵣ is the contribution to the protective separation distance attributable to the robot's reaction time;
Sₛ is the contribution to the protective separation distance due to the robot's stopping distance;
C is the intrusion distance, as defined in ISO 13855; this is the distance that a part of the body can intrude into the sensing field before it is detected;
Z_{d} is the position uncertainty of the operator in the collaborative workspace, as measured by a sensor 120 resulting from the sensing system measurement tolerance, e.g., the uncertainty of the point-cloud data generated by a sensor 120;
Zᵣ is the position/orientation uncertainty of the robot 110, resulting from the accuracy of the robot's position/orientation measurement system (e.g., joint-angle sensors).

The halt radius is measured from the surface of the robot 110 and forms a (virtual) envelope around the robot that defines the robot's halt zone 502 of FIG. 5. Using the robot joint angles received from the robot controller 118, each processing computer 150/160 dynamically moves and conforms the halt zone 502 based on the current orientation of the robot's arm 114. Thus, even if a person or other unexpected object in the environment is not moving, the safety subsystem 140 will trigger a robot halt if the robot's arm 114 moves too close to that unexpected object. In some implementations, the halt radius can be set by the operator to be larger than the minimum required by the standard, but it cannot be set smaller than that minimum.

The operator can additionally (and optionally) define a “slow radius” larger than the halt radius. This has the same functionality as the halt radius, except that, instead of triggering the robot 110 to halt when an unexpected object is determined to be too close, the robot 110 is triggered to slow down. The slow radius is not necessary for safe operation, since the halt radius is preferably set to be safe even with the robot moving at full speed. The slow radius is an additional, optional feature for the operator.

In order to reduce false positives, in some implementations, the operator can set a minimum number of points of intersection to trigger a halt. If, for example, the minimum is set to three, then, if only one or two points of intersection are determined to be within the halt zone 502, a halt will not be triggered.

### Redundant Processing Computers

The safety subsystem 140 has many layers of redundancy, including redundant processing computers 150 and 160. All calculations are performed in parallel on the independent processing computers 150 and 160. The point-cloud data 132 from the sensors 120 is sent independently to the two processing computers 150 and 160, as is the robot joint-angle data 119. All calculations are performed identically on the two processing computers 150 and 160. Each processing computer 150/160 records the time each calculation takes, as well as the timestamps for the sets of respective data 119 and 132 from the robot 110 and the sensors 120. This information allows each processing computer 150/160 to self-monitor, by checking that the aggregate latency is less than the specified allowable system latency, for example, set by the operator during configuration. In general, a larger allowable latency leads to a larger minimum halt radius. Additionally, the processing computers 150/160 send their timestamp information to each other at each frame via signal path 142, allowing for the processing computers to cross monitor.

If either the self-check or cross-check indicates too high a latency, then the frame will be marked as unsafe and the robot 110 will be halted. Additionally, if either the self-check or cross-check indicates a halt collision, then the frame will be marked as unsafe and the robot 110 will be halted. To avoid excessive stoppage, in some implementations, the robot 110 is halted only when three frames in a row fail the verification. The latency inherent to this three-frame delay is included in the maximum allowable latency, and therefore increases the halt radius.

In order to add diversity to the safety subsystem 140, in certain implementations, one processing computer runs on Windows OS and the other on Linux OS. This is to increase system robustness and decrease the likelihood of an OS-specific issue preventing safety.

### Safety Controller

The processing computers 150 and 160 send their results (halt signal, slow signal, or no-fault signal) to the safety-rated safety controller 170. In certain implementations, each processing computer 150/160 communicates with the safety controller 170 redundantly, over both an Ethernet connection 152/162 and a direct digital output voltage 154/164.

The safety controller 170 requires a fresh signal from each processing computer 150/160, for example, every 100 ms, which is included in the allowable system delay. If a fresh signal is not received from either processing computer 150/160, then the safety controller 170 triggers the robot 110 to halt.

If the signals from the processing computers 150 and 160 do not agree, then the safety controller 170 triggers the robot 110 to halt. If the processing computers both agree to halt, slow, or continue (i.e., no-fault), then the safety controller 170 will trigger the robot 110 to halt, slow, or continue, respectively.

The safety controller 170 interfaces with the robot 110 via two dual relays: dual “halt” relay 180(1) corresponding to a “halt” command and dual “slow” relay 180(2) corresponding to a slow command. For each dual relay 180, two digital-high (typically, 24-volt) outputs from the robot controller 118 are wired through the relay into two of the robot controller's own digital inputs. These inputs are monitored by the robot controller 118 to halt or slow the robot's arm 114.

### Implied Presence Zones (Blind-Spot Prevention)

Ideally, each point in the monitored space is in the view of at least two sensors 120. In reality, however, sensor views may become obscured, thereby creating “blind-spot” points that are in the view of only one sensor 120 or even no sensors 120. Such blind-spot points are defined as being part of so-called implied presence zones (IPZs). To be safe, any points within an IPZ are assumed to correspond to an unexpected object. If and when a processing computer 150/160 determines that the robot's halt zone 502 or slow zone 504 sufficiently intersects with an IPZ, then the robot's arm 114 will be halted or slowed down as appropriate, the same as the handling of detected virtual collisions with actual unexpected objects.

The IPZs are updated in near real time based on the current views of the sensors 120 and the current orientation of the robot's arm 114. For example, if an unexpected object, such as a box, is detected within the monitored space, then the points corresponding to that box will be treated as an unexpected object for detecting collisions. Furthermore, if that box blocks the view of at least one sensor 120 resulting in one or more points outside of the box no longer being within the views of at least two sensors 120, then those blind-spot points will be considered to be part of an IPZ, which, to be safe, is also treated as an unexpected object for collision-detection processing.

Note that, even if the box is programmed into the robot controller 118 as an expected object deemed to be part of an ignore zone and therefore excluded from the monitored space, like the workbench 406 of FIG. 4, any points outside that box that cannot be seen by at least two sensors 120 will still be considered to be part of an IPZ and treated as an unexpected object for collision-detection processing.

Note that the movement of the robot's arm 114 itself can result in points within the monitored space becoming blind-spots points that are therefore dynamically characterized as being part of IPZs. Note further that those same movements of the robot's arm 114 can result in other points that were previously part of IPZs no longer being blind-spot points. In that case, those points can be dynamically removed from being part of IPZs.

### Exclusion of Erroneous Robot Reflections

As described previously, the points that correspond to the current configuration of the robot 110 (aka the robot's reflection region) are themselves within an ignore zone that is excluded from the monitored space for purposes of collision-detection processing in order to prevent erroneous stoppages of the robot 110. If there are errors in the joint angles 119 received from the robot controller 118, then the virtual configuration of the robot 110 calculated by the processing computers 150/160 might not sufficiently match the actual configuration of the physical robot 110.

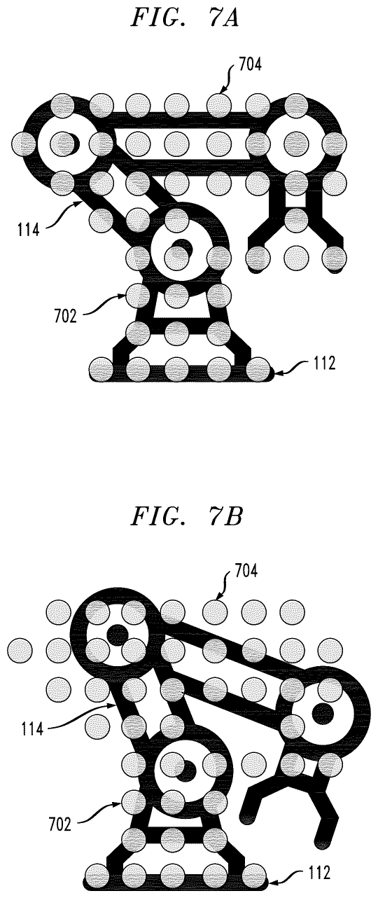

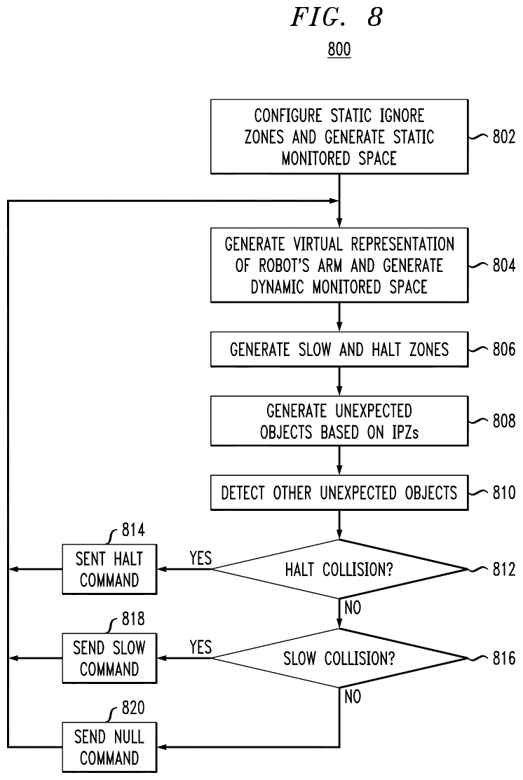

FIG. 7A represents a situation in which the received joint angles 119 are sufficiently accurate such that the points 702 of the virtual representation of the robot 110 sufficiently conform to the actual configuration of the physical robot 110.

FIG. 7B represents a situation in which some or all of received joint angles 119 are sufficiently erroneous such that the points 702 of the virtual representation of the robot 110 do not sufficiently conform to the actual configuration of the physical robot 110. In that case, the dynamic ignore zone generated around the robot will not comprehensively remove the robot reflection, and remaining points, being inside the halt radius, will necessarily trigger the robot to halt. This approach serves as a redundant safety feature provided by the safety subsystem 140.

### Timestamp Verification

In addition to verifying collision results with each other, the primary and secondary processing computers 150 and 160 also verify timestamps with each other, for example, via TCP sockets via signal path 142. Timestamps for various internal events and processes are measured by the processing computers 150 and 160 to ensure a specified, maximum latency is not exceeded. A timestamp is assigned to each frame 132 from each sensor 120 and each set of angles 119 from the robot controller 118. Moreover, all major internal processes are timestamped each time they run an iteration. These major processes include, but are not limited to, the IPZ calculations, the collision detections, the point-cloud acquisitions, and the primary-secondary communications 142. Before each processing computer 150/160 sends its collision result to the safety controller 170, the processing computer 150/160 verifies that all timestamps are within the allowable maximum latency. In some implementations, if any timestamps are not within the maximum latency, then the processing computer 150/160 instructs the robot 110 to halt.

### Fail-Safes

The safety subsystem 140 is designed to fail safely, regardless of the failure mode. Possible system component and component-connection failures are described below, as well as how these failures are safely handled.
A sensor 120 does not send frames: In this case, the timestamp for that sensor 120 will not be updated on either processing computer 150/160, since neither will receive any new frames. As a result, the previous timestamp will expire, leading to a warning display and robot halt.
View of a sensor 120 is obscured: In this case, the IPZs will reflect any blind-spot points and trigger a halt if an IPZ is within range of the robot 110.
A sensor 120 sends empty frames: As in the above case, the IPZs will reflect any blind-spot points, and trigger a halt if an IPZ is within range of the robot 110.
A sensor 120 is disconnected or loses power: In this case, the timestamp for that sensor will not be updated on either processing computer 150/160, since neither will receive any new frames. The previous timestamp will expire, leading to a warning display and robot halt.
A processing computer 150/160 does not send a result to the safety controller 170: The safety controller 170 does not receive a fresh result within a (e.g., 100 ms) window, and halts the robot 110.
A processing computer 150/160 does not communicate with the other processing computer: The communication timestamp will not be updated, the old timestamp will expire, and both processing computers 150 and 160 will send a halt signal to the safety controller 170.
The processing computers 150/160 have conflicting results: The processing computers 150 and 160 will identify a discrepancy during their communication and both send halt signals. If somehow, they still send conflicting signals to the safety controller 170, the safety controller 170 will identify a discrepancy and send a halt signal to the robot 110.
Damage to the safety controller 170: The safety controller 170 is a safety-rated piece of hardware and is designed to fail safely if damaged.

### Computer Processing

FIG. 8 is a flow diagram of processing 800 performed by each processing computer 150/160 of FIG. 1 according to certain implementations.

In the single implementation of step 802, each processing computer 150/160 is configured with static ignore zones, such as those corresponding to the workbench 406 and the spaces beyond the walls 402 and floor 404 in the example of FIG. 4 and the base 112 of the robot 110, and removes those static ignore zones from the sphere 300 of FIG. 3 to generate a static version of the monitored space.

In step 804, based on the current joint data 119, each processing computer 150/160 generates a virtual representation of the current orientation of the robot's arm 114 and removes the points corresponding to that virtual representation (i.e., the robot's reflection region) from the static version of the monitored space to generate a dynamic version of the monitored space.

In step 806, based on the static, virtual representation of the robot's base 112 and the current, dynamic, virtual representation of the robot's arm 114, each processing computer 150/160 generates current, dynamic, virtual representations of the robot's halt zone 502 and slow zone 504 of FIG. 5.

In step 808, based on the sensors' current point-cloud data 132, each processing computer 150/160 identifies points in the monitored space of step 804 that cannot be seen by at least two sensors 120 and defines those blind-spot points as being part of IPZs that will be treated as unexpected objects during the collision-detection processing of steps 812 and 816.

In step 810, based on the sensors' point-cloud data 132, each processing computer 150/160 determines whether there are any other unexpected objects in the monitored space.

In step 812, each processing computer 150/160 performs halt-collision-detection processing by comparing the unexpected objects, if any, to the robot's halt zone 502 to determine if there is a sufficient degree of intersection (e.g., an overlap of three or more points) to indicate the occurrence of a virtual, halt collision between the robot 110 and an unexpected object. If so, then, in step 814, the processing computer 150/160 sends an appropriate halt command to the safety controller 170 to instruct the robot controller 118 to halt the robot's arm 114.

If a halt collision is not detected in step 812, then, in step 816, each processing computer 150/160 performs slow-collision-detection processing by comparing the unexpected objects, if any, to the robot's slow zone 504 to determine if there is a sufficient degree of intersection to indicate the occurrence of a virtual, slow collision between the robot 110 and an unexpected object. If so, then, in step 818, the processing computer 150/160 sends an appropriate slow command to the safety controller 170 to instruct the robot controller 118 to slow down the robot's arm 114.

If a slow collision is not detected in step 816, then, in step 820, the processing computer 150/160 sends an appropriate null command to the safety controller 170 to allow the robot controller 118 to continue normal operations of the robot's arm 114.

In the implementation of FIG. 8, after the corresponding command is sent to safety controller 170 in either step 814, 818, or 820, processing returns to step 804 to repeat the processing of steps 804 et seq. for the next set of joint angles 119 and the next collection of point-cloud data 132.

If a previously detected slow collision is subsequently determined in step 812 to now be a halt collision, then a decision to halt the robot's arm 114 will replace the previous decision to slow down the robot's arm 114.

If a previously detected slow collision is subsequently determined in step 816 to cease to exist, then the decision to slow the robot's arm 114 will be canceled. In that case, in step 820, the robot 110 will be allowed to resume its normal operations.

If a previously detected halt collision is subsequently determined in step 812 to cease to exist, then the decision to halt the robot's arm 114 will be canceled. In that case, the processing of step 816 will determine whether to slow down the robot's arm 114 or allow the robot 110 to continue its normal operations. In other implementations, after a halt collision is detected in step 812 and a halt command is sent in step 814, the processing 800 of FIG. A is terminated and manual intervention is required to re-start the robot 110.

Note that some of the steps in FIG. 8 can be performed in a different order or in parallel while others cannot. For example, step 806 depends on the results of step 804, so step 806 must follow step 804. Similarly, the processing of step 808 may also depend on the results of step 804 since some of the IPZs may depend on the current orientation of the robot's arm 114, so step 808 should also follow step 804. However, the processing of steps 806, 808, and 810 may be performed in any order and/or in parallel with (i) step 812 following the completion of all three of steps 806, 808, and 810 and (ii) step 816 following step 812.

### Redundancies and Failsafes

In some implementations, some or all of the following redundant processing is performed for safety.

Robot Orientation Data: The robot orientation data 119 is sent to and processed independently by processing blocks on the separate primary and secondary processing computers 150 and 160. If either the primary processing computer 150 or the secondary processing computer 160 does not receive robot orientation data 119 from the robot 110 in time, then the safety subsystem 140 triggers a halt. The primary processing computer 150 verifies that the secondary processing computer 160 received robot orientation data 119 in time. If not, then the safety subsystem 140 triggers a halt. Similarly, the secondary processing computer 160 verifies that the primary processing computer 150 received robot orientation data 119 in time. If not, then the safety subsystem 140 triggers a halt. If the robot's reflection region is observed by the sensors 120 to deviate from the robot orientation reported to the primary processing computer 150 by more than a specified distance, then the safety subsystem 140 triggers a halt. Similarly, if the robot's reflection region is observed by the sensors 120 to deviate from the robot orientation reported to the secondary processing computer 160 by more than a specified distance, then the safety subsystem 140 triggers a halt.

Sensor Point Clouds: Sensor point-cloud data 132 is sent to and processed independently by processing blocks on the separate primary and secondary processing computers 150 and 160. Sensor point clouds 132 from the different sensors 120 are independently merged by the primary and secondary processing computers 150 and 160. Each of the primary and secondary processing computers 150 and 160 independently verifies that it has received data 132 from each sensor 120 in time. If not, then the safety subsystem 140 triggers a halt. The secondary processing computer 160 verifies that the primary processing computer 150 has received data 132 from each sensor 120 in time, and vice versa. If not, then the safety subsystem 140 triggers a halt. Each of the primary and secondary processing computers 150 and 160 independently assumes that any space within reach of the robot 110 that is not in view of at least two sensors 120 is occupied by a person (i.e., an implied presence zone). The primary and secondary processing computers 150 and 160 independently verify that the results of their two processings are identical. If either of the primary and secondary processing computers 150 and 160 loses connection to any of the sensors 120, it automatically reconnects. In the meantime, each processing computer 150/160 independently removes data 132 from that sensor 120 and assumes that any space within reach of the robot 110 that is not in view of at least two sensors 120 to be occupied by a person (i.e., in an implied presence zone). If either processing computer 150/160 independently determines that a point of egress into the cell is within range of the robot+the collision radius, then the safety subsystem 140 triggers a halt. If a sensor 120 loses power, then it will not send current data 132 to the processing computers 150/160, the corresponding timestamps will not be updated, and the safety subsystem 140 will trigger a halt.

Processing Computers: The primary and secondary processing computers 150 and 160 divide communications with each other over two independent sockets. The connection is verified at every frame. If either socket loses connection or communication fails, then the safety subsystem 140 triggers a halt. If either processing computer 150/160 does not independently calculate the implied presence zones (IPZs) in time, then the safety subsystem 140 triggers a halt. If either processing computer 150/160 independently determines that the other processing computer did not calculate the IPZs in time, then the safety subsystem 140 triggers a halt. If either processing computer 150/160 independently determines that the other processing computer did not generate collision results in time, then the safety subsystem 140 triggers a halt. If either processing computer 150/160 loses power, then the corresponding heartbeat signal to the safety controller 170 will not be updated and the safety subsystem 140 will trigger a halt.

Presence Detection: The presence of any unaccounted objects within range of the robot 110 will trigger a slow command or a halt command, depending on the distance. The number of offending points required to trigger a halt can be configured. The halt radius is calculated according to ISO/TS 15066:2016(E). The primary processing computer 150 compares the collision results of the secondary processing computer 160 with its own collision results, and vice versa for the secondary processing computer 160. If the collision results do not agree, then the safety subsystem 140 triggers a halt. Any misalignment in any results triggers a halt. Each processing computer 150/160 independently sends halt signals to the safety controller 170.

Safety Controller: The safety controller 170 independently receives halt signals 152/154 and 162/164 from each processing computer 150/160 and triggers a halt if either processing computer 150/160 sends a halt signal. The safety controller 170 sends two redundant halt signals 172(1) to the robot controller 118, which halts the robot 110 if either signal is a halt signal. If the safety controller 170 loses Ethernet connection to either processing computer 150/160, then the safety subsystem 140 triggers a halt. If the safety controller 170 loses heartbeat from either processing computer 150/160, then the safety subsystem 140 triggers a halt. If the safety controller 170 determines that the signals 152, 154, 162, and 164 from the processing computers 150 and 160 do not all agree, then the safety subsystem 140 triggers a halt. If the safety controller 170 does not receive a signal 152/154/162/164 from either processing computer 150/160 in time, then the safety subsystem 140 triggers a halt. If the safety controller 170 loses power, then, as a safety-rated device, it will fail-safe, halting the robot 110 when not powered. This is possible since the relays 180 are “normally open”, meaning that a loss of power will leave the relay open by default, triggering the robot 110 to halt. The safety controller 170 sends (i) halt signals 172(1) to the first relay 180(1) with a first set of dual cables and (ii) slow signals 172(2) to the second relay 180(2) with a second set of dual cables. For additional redundancy, two instances of the first relay 180(1) can be employed instead of one instance, with the robot 110 responding to a halt signal from either of the redundant first relays 180(1). Analogously, two instances of the second relay 180(2) can also be employed.

Multicast Computer: If a multicast computer 130 does not receive data 122 from the corresponding sensor 120, then the multicast computer 130 will not forward updated information 132 to the processing computers 150 and 160, which will trigger a halt. If a multicast computer 130 is damaged or loses power, then the multicast computer 130 will not forward updated information 132 to the processing computers 150 and 160, which will trigger a halt.

### Alternative System Architectures

FIG. 9 is a schematic block diagram representing the hardware infrastructure of an industrial robotics system 900 according to certain other embodiments of the present disclosure. Robotics system 900 is analogous to robotics system 100 of FIG. 1 with analogous elements labeled with the analogous labels. The main difference between robotics system 900 and robotics system 100 is that, instead of having multicast computers 130 that multicast the point-cloud data 132 to the primary and secondary processing computers 150 and 160 as in robotics system 100, robotics system 900 has unicast computers 930, each of which transmits the corresponding sets of point-cloud data 932 to a managed switch 944 in the safety subsystem 940 that then distributes identical copies of the point-cloud data to the primary and secondary processing computers 950 and 960 via respective signal paths 946 and 948. Managed switch 944 may be implemented using an XGM1915-18EP managed switch from Zyxel Networks of Hsinchu, Taiwan.

In some implementations, Ethernet signals 952 and 962 from the processing computers 950 and 960 are transmitted to the safety controller 970 via the managed switch 944 and signal path 945.

In some alternative embodiments, the unicast computers 930 are omitted, and the sensors 920 transmit their data directly to the managed switch 944.

In all other respects, the operations of robotics system 900 are similar if not identical to the operations of robotics system 100 of FIG. 1.

### Multiple Robots/Multiple Robot Arms

The disclosure has been described in the context of an industrial workspace having a single robot with a single movable arm, as in the robot 110 of FIG. 1. In other embodiments, an industrial workspace may have two or more robots working in parallel and/or one or more robots each having multiple arms working in parallel. In such an embodiment, each robot/robot arm may have its own safety subsystem similar to safety subsystem 140 of FIG. 1, with each robot/robot arm having its own robot controller 118, its own set of signaling lines 172(1) and 172(2), its own pair of relays 180(1) and 180(2), and its own relay loops 182(1) and 182(2), or a single safety subsystem may be responsible for detecting slow and halt collisions for two or more of the robots and/or for two or more of the robot arms. In either case, in some implementations, it is assumed that the robot controllers will be programmed to avoid actual robot-to-robot collisions. In other implementations, that assumption does not apply. In those latter implementations, for each given robot/robot arm, the processing 800 of FIG. 8 may be performed, where every other robot/robot arm in the workspace is treated as an unexpected object for the collision-detection processing of the given robot/robot arm.

### Mobile Robots

The disclosure has been described in the context of an industrial workspace having a stationary robot whose base does not move relative to the workspace, as in the stationary robot 110 of FIG. 1. In other embodiments, in addition to or instead of one or more stationary robots, a workspace may have one or more mobile robots, each of which can move within the workspace.

A mobile robot may have an arm mounted to the mobile robot and able to move with respect to the mobile robot's chassis, such as a mobile version of the robot 110 of FIG. 1. Alternatively, a mobile robot may be just a mobile base without a movable arm, such as a mobile workbench that moves a collection of workpieces from one location to another within a monitored space. In that case, depending on the frame of reference employed by the safety subsystem, the position and/or orientation—but not the shape—of the halt and slow zones around the robot may need to be updated dynamically based on the position and/or orientation of the robot within the monitored space.

In any of these implementations, for each given mobile robot, the processing 800 of FIG. 8 may be performed, but with some of the static ignore zones used to generate, for a stationary robot, the static monitored space during the single execution of step 802 now being treated as dynamic ignore zones in the generation of the dynamic monitored space of step 804. Note that the sphere 300 of FIG. 3 will move with the mobile robot, resulting in the ignore zones corresponding to at least the walls 402 and the workbench 406 of FIG. 4 needing to be treated as dynamic ignore zones as the mobile robot moves within the workspace. If a mobile robot moves only laterally, then the ignore zone corresponding to the floor should be able to continue to be treated as a static ignore zone in step 802 of FIG. 8. If the entire robot moves vertically, then the floor's ignore zone, but perhaps not the walls' ignore zones, will need to be treated as a dynamic ignore zone in step 804 of FIG. 8. If the robot's base moves with the robot, then the base's ignore zone should be able to continue to be treated as a static ignore zone in step 802.

If and when a halt or slow collision is detected for a mobile robot, a command/instruction to halt or slow the mobile robot may include halting or slowing down the movement of the robot's base relative to the robot's environment as well as halting or slowing down the movement of the robot's arm, if any, relative to the robot's base.

### Internal Sensors

The disclosure has been described in the context of robotic systems having “external” sensors, such as sensors 120 of FIG. 1, that are mounted external to the robot and look towards the robot. In other embodiments, in addition to or instead of having external sensors, a robotics system may have one or more “internal” sensors, each of which is mounted onto either the robot's base or on a segment of the robot's arm and looks out from the robot. In such an embodiment, the processing 800 of FIG. 8 can also be performed.

For mobile robots, the positions and/or orientations of any arm-mounted sensors would be recalculated each frame in near real time, based on the robot's dynamic location and/or orientation, the robot arm's dynamic orientation, and the sensor's mounting point on the robot's arm. For stationary robots, the positions and orientations of any arm-mounted sensors would be recalculated each frame in near real time, based on the robot arm's dynamic orientation and the sensor's mounting point on the robot's arm.

The changing positions and orientations of any such internal sensors would be taken into account in step 808 in generating the dynamic unexpected objects corresponding to IPZs. The robot's reflection region would continue to be removed as with external sensors. A sufficient set of sensors would be mounted to guarantee a comprehensive view of the monitored space to compensate for the robot's arm blocking certain sensor's views depending on the sensor's FoV and the arm's current orientation.

In some implementations, the functionality of the safety subsystem 140 and the relays 180(1) and 180(2) could be implemented by components on one or more circuit boards built into the robot controller 118.

### NON-REDUNDANT EMBODIMENTS

Although the disclosure has been described in the context of redundant embodiments that multicast signals to the primary and secondary computers 150 and 160 of FIG. 1 operating in parallel to generate redundant control signals that provide extra safety precaution, also possible are non-redundant embodiments having a single processing computer. Such embodiments may be implemented without a safety controller (e.g., 170 of FIG. 1) and may involve a single relay between the safety subsystem and the robot.

### OTHER ALTERNATIVE EMBODIMENTS

Although the disclosure has been described in the context of embodiments that generate and employ halt and slow zones to detect halt and slow collisions, in some implementations, the slow zones and the detection of slow collisions may be optional.

Although the disclosure has been described in the context of embodiments that generate halt and slow zones around the robot, in alternative embodiments, halt and/or slow zones could instead be generated around the unexpected objects.

Although the disclosure has been described in the context of embodiments where the sensors are 3D cameras that generate optical images, in alternative embodiments, the sensors may be or include other suitable types of devices for detecting unexpected objects, such as time-of-flight sensors that transmit outgoing signals and receive corresponding reflected incoming signals, infrared sensors, stereoscopic cameras, LIDAR, structured light, and other technologies.

In certain embodiments, the present disclosure is a computer-based method for a safety subsystem altering normal operations of a robot within a monitored space around the robot, the method comprising the safety subsystem (i) generating a virtual representation of the robot using position and/or orientation data associated with the robot; (ii) detecting an unexpected object within the monitored space using sensor data from a plurality of sensors; (iii) generating a halt zone corresponding to the robot or the unexpected object; (iv) determining whether a virtual halt collision has occurred between the robot and the unexpected object based on the halt zone; and (v) upon determining that a virtual halt collision has occurred, generating an instruction to halt the normal operations of the robot.

In at least some of the above embodiments, the robot comprises an arm connected to a base (e.g., platform, floor, or some other structure), wherein the normal operations involve movement of the arm relative to the base within the monitored space; the virtual representation of the robot comprises a virtual representation of a current orientation of the arm relative to the base using orientation data associated with the arm; and upon determining that a virtual halt collision has occurred, generating an instruction to halt the movement of the arm relative to the base.

In at least some of the above embodiments, the orientation data comprises joint-angle data corresponding to joints in the arm.

In at least some of the above embodiments, the robot is a stationary robot whose base is immobile.

In at least some of the above embodiments, the unexpected object is another robot within the monitored space.

In at least some of the above embodiments, the unexpected object is a person within the monitored space.

In at least some of the above embodiments, the safety subsystem generates the halt zone corresponding to the robot.

In at least some of the above embodiments, the method further comprises the safety subsystem generating a slow zone corresponding to the robot; determining whether a virtual slow collision has occurred between the robot and the unexpected object based on the slow zone; and, upon determining that a virtual slow collision has occurred, generating an instruction to slow down the normal operations of the robot.

In at least some of the above embodiments, the safety subsystem generates the monitored space by excluding the volume described by one or more ignore zones from an initial version of the monitored space, where an ignore zone corresponds to a region within the initial version of the monitored space that is outside the reach of the robot under the normal operations.

In at least some of the above embodiments, the initial version of the monitored space is a sphere surrounding the robot.

In at least some of the above embodiments, the one or more ignore zones comprise one or more of a region beyond a wall of the robot's environment; a region beyond a floor of the robot's environment; or an expected object within the robot's environment.

In at least some of the above embodiments, the one or more ignore zones comprise a reflection region corresponding to the robot itself.

In at least some of the above embodiments, the safety subsystem updates the reflection region in near real time based on current orientation of the robot relative to its base or mounting position.

In at least some of the above embodiments, the one or more ignore zones comprise at least one other robot and/or at least one other arm of the robot within the robot's environment.

In at least some of the above embodiments, the robot is a mobile robot whose base moves with respect to the robot's environment, and the safety subsystem updates the monitored space in near real time based on movement of the robot's base within the robot's environment.

In at least some of the above embodiments, the safety subsystem receives at least some of the sensor data from an external sensor.

In at least some of the above embodiments, the safety subsystem receives at least some of the sensor data from an internal sensor mounted on a base of the robot.

In at least some of the above embodiments, the safety subsystem receives at least some of the sensor data from an internal sensor mounted on an arm of the robot that moves relative to a base of the robot.

In at least some of the above embodiments, the safety subsystem defines one or more implied presence zones (IPZs) corresponding to one or more regions within the monitored space having insufficient coverage by the sensors, wherein the safety subsystem treats each IPZ as an unexpected object within the monitored space.

In at least some of the above embodiments, the safety subsystem defines a point within the monitored space as having insufficient coverage upon determining that the point is within the view of fewer than two of the sensors.

In at least some of the above embodiments, the safety subsystem updates at least one of the IPZs in near real time based on the movement of an arm of the robot relative to a base of the robot.

In at least some of the above embodiments, the safety subsystem comprises two processing computers and a safety controller, wherein the two processing computers independently perform the method of claim 1 in parallel; the safety controller determines whether the instructions from the processing computers match; and, upon determining that the instructions from the processing computers do not match, the safety controller generates an instruction to halt the normal operations of the robot.

In at least some of the above embodiments, a first of the two processing computers determines whether its instruction matches the other processing computer's instruction and, upon determining that its instruction does not match the other processing computer's instruction, the first processing computer generates an instruction to halt the normal operations of the robot.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure.

As used herein in reference to an element and a standard, the terms “compatible” and “conform” mean that the element communicates with other elements in a manner wholly or partially specified by the standard and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits. The term “non-transitory,” as used herein, is a limitation of the medium itself (i.e., tangible, not a signal) as opposed to a limitation on data storage persistency (e.g., RAM vs. ROM).

Signals and corresponding terminals, nodes, ports, links, interfaces, or paths may be referred to by the same name and/or label and are interchangeable for purposes here.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

All documents mentioned herein are hereby incorporated by reference in their entirety or alternatively to provide the disclosure for which they were specifically relied upon.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A computer-based method for a safety subsystem altering normal operations of a robot within a monitored space around the robot, the method comprising the safety subsystem:
generating a virtual representation of the robot using position and/or orientation data associated with the robot;
detecting an unexpected object within the monitored space using sensor data from a plurality of sensors;
generating a halt zone corresponding to the robot or the unexpected object;
determining whether a virtual halt collision has occurred between the robot and the unexpected object based on the halt zone; and
upon determining that a virtual halt collision has occurred, generating an instruction to halt the normal operations of the robot.

2. The method of claim 1, wherein:
the robot comprises an arm connected to a base, wherein the normal operations involve movement of the arm relative to the base within the monitored space;
the virtual representation of the robot comprises a virtual representation of a current orientation of the arm relative to the base using orientation data associated with the arm; and
upon determining that a virtual halt collision has occurred, generating an instruction to halt the movement of the arm relative to the base.

3. The method of claim 2, wherein the orientation data comprises joint-angle data corresponding to joints in the arm.

4. The method of claim 2, wherein the robot is a stationary robot whose base is immobile.

5. The method of claim 1, wherein the unexpected object is another robot within the monitored space.

6. The method of claim 1, wherein the unexpected object is a person within the monitored space.

7. The method of claim 1, wherein the safety subsystem generates the halt zone corresponding to the robot.

8. The method of claim 1, further comprising the safety subsystem:
generating a slow zone corresponding to the robot or the unexpected object;
determining whether a virtual slow collision has occurred between the robot and the unexpected object based on the slow zone; and
upon determining that a virtual slow collision has occurred, generating an instruction to slow down the normal operations of the robot.

9. The method of claim 1, wherein the safety subsystem generates the monitored space by removing one or more ignore zones from an initial version of the monitored space, where an ignore zone corresponds to a region within the initial version of the monitored space that is outside the reach of the robot under the normal operations.

10. The method of claim 9, wherein the initial version of the monitored space is a sphere surrounding the robot.

11. The method of claim 9, wherein the one or more ignore zones comprise one or more of:
a region beyond a wall of the robot's environment;
a region beyond a floor of the robot's environment; and
an expected object within the robot's environment.

12. The method of claim 9, wherein the one or more ignore zones comprise a reflection region corresponding to the robot itself.

13. The method of claim 12, wherein the safety subsystem updates the reflection region in near real time based on current orientation of an arm of the robot relative to a base of the robot.

14. The method of claim 9, wherein the one or more ignore zones comprise at least one other robot and/or at least one other arm of the robot within the robot's environment.

15. The method of claim 1, wherein:
the robot is a mobile robot whose base moves with respect to the robot's environment; and
the safety subsystem updates the monitored space in near real time based on movement of the robot's base within the robot's environment.

16. The method of claim 1, wherein the safety subsystem receives at least some of the sensor data from an external sensor.

17. The method of claim 1, wherein the safety subsystem receives at least some of the sensor data from an internal sensor mounted on a base of the robot.

18. The method of claim 1, wherein the safety subsystem receives at least some of the sensor data from an internal sensor mounted on an arm of the robot that moves relative to a base of the robot.

19. The method of claim 1, wherein the safety subsystem defines one or more implied presence zones (IPZs) corresponding to one or more regions within the monitored space having insufficient coverage by the sensors, wherein the safety subsystem treats each IPZ as an unexpected object within the monitored space.

20. The method of claim 19, wherein the safety subsystem defines a point within the monitored space as having insufficient coverage upon determining that the point is within the view of fewer than two of the sensors.

21. The method of claim 19, wherein the safety subsystem updates at least one of the IPZs in near real time based on the movement of an arm of the robot relative to a base of the robot.

22. The method of claim 1, wherein the safety subsystem comprises two processing computers and a safety controller, wherein:
the two processing computers independently perform the method of claim 1 in parallel;
the safety controller determines whether the instructions from the processing computers match; and
upon determining that the instructions from the processing computers do not match, the safety controller generates an instruction to halt the normal operations of the robot.

23. The method of claim 22, wherein:
a first of the two processing computers determines whether its instruction matches the other processing computer's instruction; and
upon determining that its instruction does not match the other processing computer's instruction, the first processing computer generates an instruction to halt the normal operations of the robot.

24. A safety subsystem for altering normal operations of a robot within a monitored space around the robot, the safety subsystem comprising at least one processing computer configured to:
generate a virtual representation of the robot using position and/or orientation data associated with the robot;
detect an unexpected object within the monitored space using sensor data from a plurality of sensors;
generate a halt zone corresponding to the robot or the unexpected object;
determine whether a virtual halt collision has occurred between the robot and the unexpected object based on the halt zone; and
upon determining that a virtual halt collision has occurred, generate an instruction to halt the normal operations of the robot.
